(19) United States
(12) Patent Application Publication
(10) Pub. No.: US 2003/0067230 A1
(43) Pub. Date: Apr. 10, 2003

(54) Maximum torque-per-ampere control of a saturated surface-mounted permanent magnet machine

(76) Inventors: Constantin C. Stancu, Anaheim, CA (US); Silva Hiti, Redondo Beach, CA (US)

Correspondence Address: CHRISTOPHER DEVRIES, General Motors Corporation, Legal Staff, Mail Code 482-C23-B21, P.O. Box 300, Detroit, MI, 48265-3000, US

(21) Appl. No.: 09/973,685

(22) Filed: Oct. 9, 2001

(51) Int. Cl. H02K 11/00

(52) U.S. Cl. 310/68 D

(57) ABSTRACT

An electric motor control system including a stator for producing a magnetic field, a surface mount permanent magnet rotor rotated by the magnetic field, a motor shaft coupled to the rotor, power electronics for controlling the magnetic field in the stator, and where the power electronics controls the q-axis and d-axis current components for the electric motor.

### TECHNICAL FIELD

The present invention relates to an electric drive system comprised of a surface-mounted permanent magnet electric machine powered by a voltage source inverter and a controller. More specifically, the present invention relates to a method and apparatus to increase the shaft torque output for a surface-mounted permanent magnet machine.

### BACKGROUND OF THE INVENTION

In today's automotive market, there exist a variety of electric propulsion or drive technologies used to power vehicles. The technologies include electric traction motors such as DC motors, AC induction motors, switched reluctance motors, synchronous reluctance motors, brushless DC motors and corresponding power electronics. An electric motor may be described as generally comprising a stator and a rotor. The stator is fixed in position and the rotor moves relative to the stator. Permanent magnet excited synchronous machines are of particular interest for use as traction motors in an electric vehicle because of their superior performance characteristics, as compared to DC motors and AC induction motors.

In permanent magnet excited synchronous machines, the stator is typically the current carrying component of the motor, generating a magnetic field to interact with the rotor. The field generated by the stator will propel or rotate the rotor relative to the stator via the magnetic field. Permanent magnet excited synchronous machines operate with a permanent magnet rotor. A permanent magnet rotor may be configured as a surface mount or interior or buried permanent magnet rotor. In a permanent magnet excited synchronous machine equipped with a surface mount permanent magnet (SMPM) rotor, magnets are mounted on the surface of the rotor.

### SUMMARY OF THE INVENTION

The present invention is a method and apparatus for increasing the torque of a surface-mounted permanent magnet machine or motor by using saturation-induced reluctance torque.

The electromagnetic torque of a three-phase SMPM machine is represented by equation (1).

Te=3/2PΨₘi_{q} (1)

It can be derived using the general equation of the electromagnetic torque in a reference frame attached to the rotor as follows:

Tₑ=3/2P(Ψ_{d}i_{q}−Ψ_{q}i_{d}) (2)

Ψ_{d}=Ψₘ+L_{d}i_{d} (3)

Ψ_{q}=L_{q}i_{q} (4)

Equation 2 may be represented as:

Tₑ=3/2P[Ψₘi_{q}+(L_{d}−L_{q})i_{q}i_{d}] (5)

where

Tₑ is the electromagnetic torque,

Ψₘ is the permanent magnet flux linkage,

Ψ_{d} and Ψ_{q} are the direct and the quadrature axis stator flux linkages in the rotor reference frame,

i_{d} and i_{q} are stator current components, and

P is the number of pole pairs of the machine.

A simplified phasor diagram of an SMPM machine is shown in FIG. 1 including the variables illustrated by equations 1-5. The d-axis is defined as being aligned to the permanent magnet flux Ψₘ and the q-axis is 90 electrical degrees in advance. Vₛ corresponds to the stator voltage, and Iₛ corresponds to the stator current. In traditional SMPM machine control theory, L_{d} is considered equal to L_{q}, rending the second term of equation 5 equal to zero and making equation 5 the same as equation 1.

At high stator current levels, when the effects of magnetic saturation cannot be neglected, the two magnetizing inductances can have different values where L_{d} is not equal to L_{q}. In these cases, the difference (L_{d}−L_{q}) is not zero, and additional torque can be obtained from the motor if the d-axis current is controlled to an optimal, non-zero value.

### BRIEF DESCRIPTION OF THE DRAWINGS

FIG. 1 is a phasor diagram of an SMPM machine;

FIG. 2 is a diagrammatic cut-away drawing illustrating an electric motor of the present invention;

FIG. 3 is a control block diagram for a SMPM machine;

FIG. 4 is a plot illustrating the increase in torque generated by the present invention; and

FIG. 5 is a plot illustrating the torque/amperes generated by the present invention.

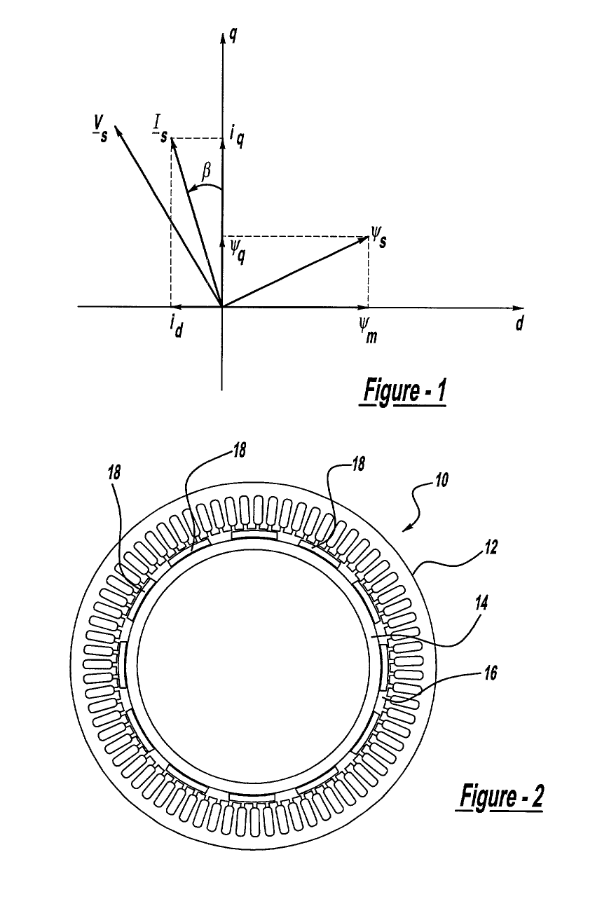

### DESCRIPTION OF THE PREFERRED EMBODIMENT

FIG. 2 is a cut-away view of an electric motor 10 of the present invention. The electric motor 10 includes a stator 12 and rotor 14 separated by an air gap 16. The electric motor 10 in the preferred embodiment is configured as a three-phase surface mount permanent magnet machine. The rotor 14 is configured as a surface mount permanent magnet (SMPM) rotor with magnets 18 coupled to the surface of the rotor 14. The magnets 18 are preferably rare earth magnets.

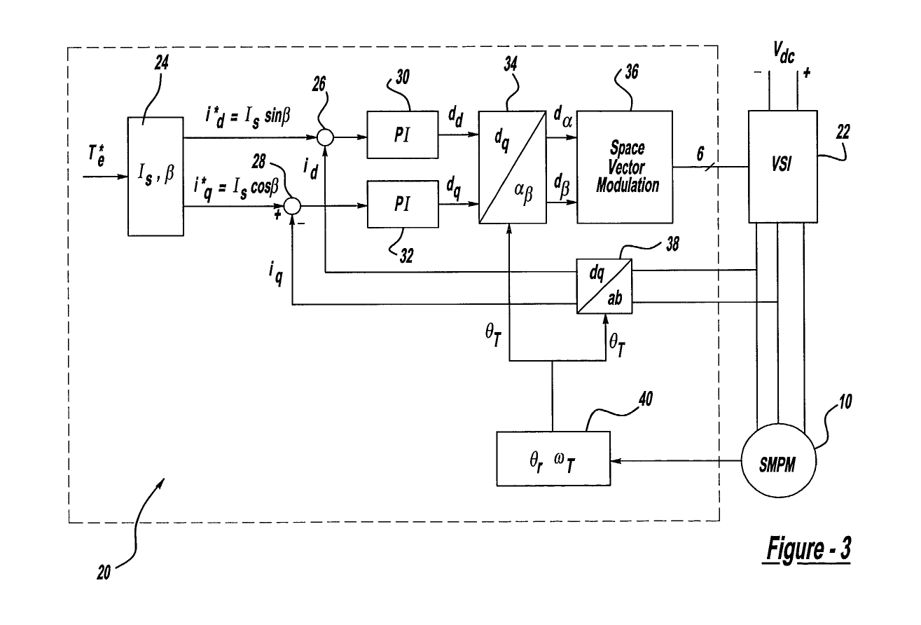

FIG. 3 is a control block diagram for the motor 10 in the preferred embodiment of the invention. A controller 20 contains software to control the power electronics 22 that operates the motor 10. The controller 20 may comprise any known controller in the electronic and computer arts. The power electronics 22 are preferably comprised of a voltage source inverter (VSI). A high voltage DC bus V_{dc} provides power to the power electronics 22. Tₑ* is the torque setpoint input to block 24. Block 24 transforms Tₑ* into current setpoints i_{q}* and i_{d}*. The transformation at block 24 is executed as a function of the angle β made by the stator current Iₛ with the q-axis as follows:

i_{q}*=Iₛ cos β

i_{d}*=Iₛ sin β

The angle β is assigned an initial value of zero. The angle β may then be varied to produce the desired current setpoints.

The current setpoint i_{q}* is input to a summing junction 28 along with current feedback i_{q} provided by block 38. The resultant error is processed by proportional integral (PI) control block 34 and space vector modulator 36 to switch or drive the power electronics 22 in response to the error. Similarly, at block 26 the current setpoint i_{d}* is summed with current feedback id at summing junction 26 to generate an error that is processed by PI control block 36 and the space vector modulator 36 to switch or drive the power electronics 22 in response to the error. In past control systems, the current id was assumed to be zero. The present invention controls the current id to a non-zero value to increase the torque of the electric motor 10. Torque is also controlled by controller 20 with reference to feedback 40 providing θᵣ position and ωᵣ speed information for the motor 10.

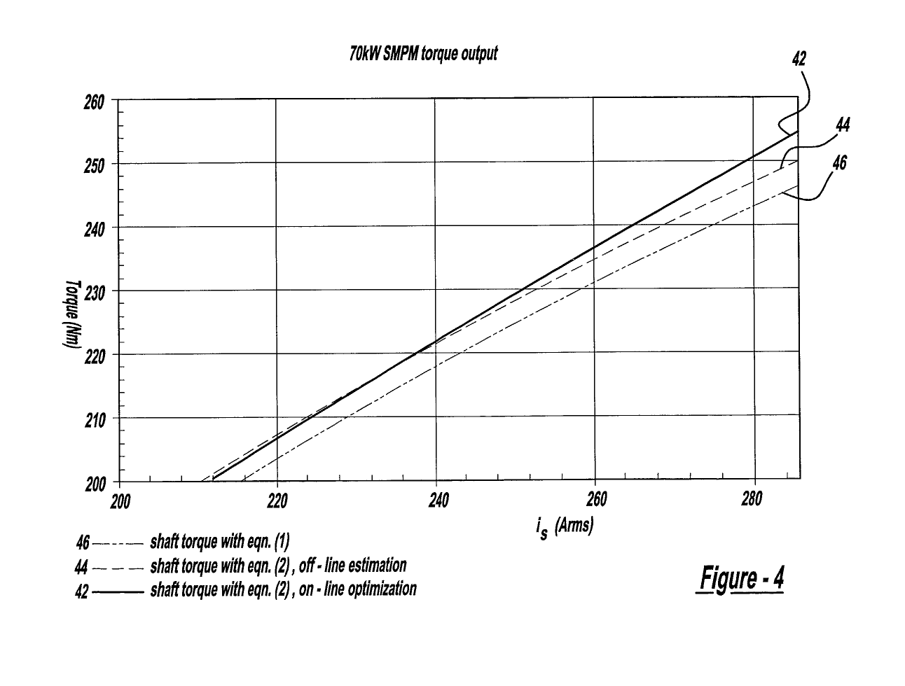

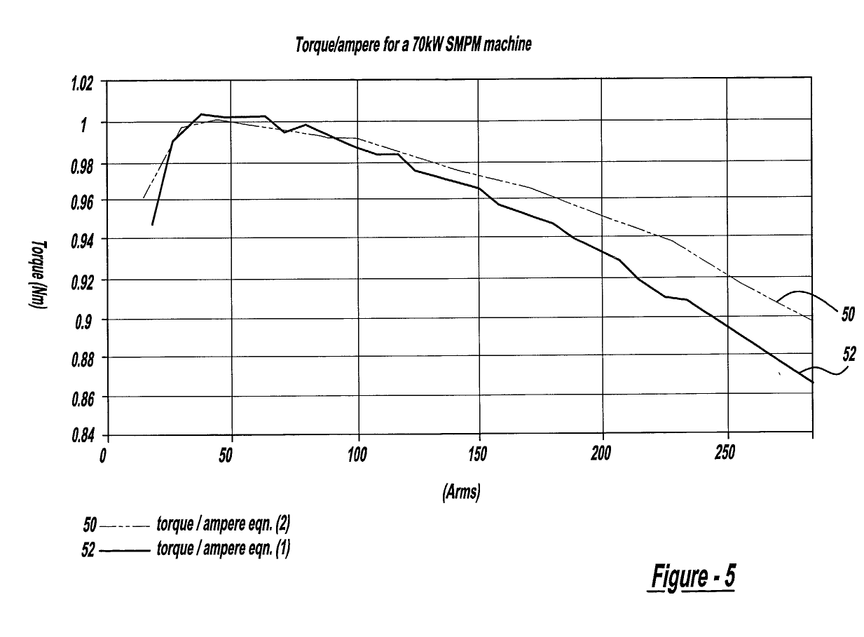

The machine measured torque output vs. stator current is illustrated in FIG. 4 for the motoring mode of the electric motor 10. The torque of the motor 10 can be increased if the stator current i_{q} is not aligned along the q-axis of the motor, but rather slightly in advance, corresponding to the presence of a small negative d-axis current component. Plot 44 in FIG. 4 corresponds to an off-line estimation of motor torque according to equation 1, plot 42 corresponds to an on-line or operating optimization of motor torque using equation 5, and plot 46 corresponds to motor torque using equation 1. As can be seen by comparing plot 42 and plot 46, by controlling id to a non-zero value, torque for the electric motor 10 can be augmented. Similarly, in FIG. 5, plot 50 corresponds to an on-line or operating optimization of motor torque/ampere using equation 5, and plot 52 corresponds to motor torque using equation 1. As illustrated by the plots of FIGS. 4 and 5, by controlling the current id during magnetic saturation conditions, the torque of the electric motor 10 can be increased, as compared to past motor control algorithms that ignored control of the id component to generate torque.

While this invention has been described in terms of some specific embodiments, it will be appreciated that other forms can readily be adapted by one skilled in the art. Accordingly, the scope of this invention is to be considered limited only by the following claims.

1. An electric motor control system comprising:
a stator for producing a magnetic field;
a surface mount permanent magnet rotor rotated by said magnetic field;
a motor shaft coupled to said rotor;
power electronics for controlling said magnetic field in said stator; and
wherein said power electronics controls the q-axis and d-axis current components for the electric motor.

2. The electric motor control system of claim 1 wherein said stator includes current carrying coils to generate said magnetic field.

3. The electric motor control system of claim 1 wherein said surface mount permanent magnet rotor includes rare earth magnets.

4. The electric motor control system of claim 1 wherein said power electronics comprises a voltage source inverter.

5. The electric motor control system of claim 1 further comprising a controller controlling said power electronics, said controller including a control block to control the d-axis current as a function of the angle β.

6. A method of controlling an electric motor comprising:
providing an electric motor having a wound stator, a rotor magnetically coupled to said wound stator, said rotor including surface mount permanent magnets;
controlling q-axis current in the stator; and
controlling d-axis current in the stator.

7. The method of claim 6 wherein the step of controlling the q-axis current in the stator comprises controlling the q-axis current as a function of the angle β.

8. The method of claim 6 wherein the step of controlling the d-axis current in the stator comprises controlling the d-axis current as a function of the angle β.

9. The method of claim 6 further comprising the step of controlling the position of the electric motor.

10. A method of controlling an electric motor comprising:
providing an electric motor having a wound stator, a rotor magnetically coupled to said wound stator, said rotor including surface mount permanent magnets;
providing a vector controller and voltage switched inverter to provide stator current to the wound stator; and
controlling the q-axis and d-axis current components of the stator current to control the torque of the electric motor.

11. The method of claim 10 further comprising the step of determining the position of said rotor.

12. The method of claim 11 further comprising the step of determining the actual current of the electric motor.

13. The method of claim 12 further comprising the step of calculating the d-axis current setpoint as a function of the angle of the stator current vector with reference to the q-axis.
